(19) United States
(12) Patent Application Publication
(10) Pub. No.: US 2006/0250499 A1
(43) Pub. Date: Nov. 9, 2006

(54) Arrangement for management of a soldier in network-based warfare

(75) Inventors: Christer Regebro, Eskilstuna (SE); Martin Vestin, Vasteras (SE)

Correspondence Address: VENABLE LLP, P.O. BOX 34385, WASHINGTON, DC, 20045-9998, US

(73) Assignee: SAAB AB, LINKOPING (SE)

(21) Appl. No.: 11/350,760

(22) Filed: Feb. 10, 2006

(30) Foreign Application Priority Data
Feb. 11, 2005 (EP) 05445006.9

(51) Int. Cl. H04N 7/18; H04N 7/00; H04N 9/47

(52) U.S. Cl. 348/113

(57) ABSTRACT

An arrangement for management of a soldier in network-based warfare. The arrangement includes sighting-related equipment for position determination, taking measurements and communication with the environment. The arrangement gives the soldier adequate information in an accessible way without subjecting the soldier to unnecessary loads. The sighting-related equipment is arranged in a combined unit carried by the soldier and information produced by the equipment is at least partially displayed superimposed on a display device.

The present invention relates to an arrangement for management of a soldier in network-based warfare, which arrangement comprises equipment for position determination, taking measurements and communication with the environment.

In the future, warfare will make high demands regarding the tasks that a soldier is to be able to carry out. The soldier must be able to carry out current tasks more efficiently and must be able to be used in a more versatile way. In the future, a single soldier must be able to carry out tasks that to date have required several individuals in specially organized units.

A restricting factor for each individual soldier is the quantity of equipment that he can reasonably carry without excessive exertion. Examples of equipment that the soldier normally requires are positioning equipment, measuring equipment, personal protection, personal weapons, ammunition and communication equipment. Constraining factors are the ability of the individual soldier to carry and handle this equipment and restrictions imposed by the soldier's mental ability.

The object of the present invention is to achieve an arrangement for management of a soldier according to the first paragraph that gives the soldier adequate information in an accessible way, while at the same time he or she is not subjected to unnecessary loads. The object of the invention is achieved by an arrangement characterized in that the sighting-related equipment is arranged in a combined unit carried by the soldier and in that information produced by the equipment is at least partially displayed superimposed on a display device. Sighting-related equipment means sensors for measuring targets, target indicators and other equipment that is associated with the movement or alignment of the sighting-related equipment. By coordinating all the sighting-related equipment in one unit and arranging for the display to be coordinated, an arrangement is achieved which is compact and light to carry and which can display the relevant information in a simple and clear way.

According to an advantageous embodiment of the invention, the arrangement's sighting-related equipment is provided with a means for mounting it on a weapon carried by the soldier. The embodiment has the advantage that the arrangement's sighting-related equipment can be handled at the same time as the weapon in one unit. According to an alternative embodiment, the arrangement's sighting-related equipment is designed to be hand-held in the same way as a telescope. This embodiment can suitably be used, for example, when mounting it on the weapon would subject the arrangement's sighting-related equipment to too great a load or when the soldier does not carry a weapon.

According to another advantageous embodiment of the invention, the equipment for position determination comprises an inertial navigation system. This system enables the soldier to obtain a precise position even in locations where it is not possible to determine the position by satellite communication. The position can be obtained in three dimensions.

According to yet another advantageous embodiment, the arrangement can comprise a positioning system of the global type, such as GPS.

The positioning system of the global type is advantageously combined with position determination utilizing inertial navigation. A suitable arrangement of this kind is characterized in that the equipment for position determination comprises an inertial navigation system working together with a positioning system of the global type. When no signals are available in the global positioning system, the inertial navigation system takes over in order to provide adequate position information. When the global positioning system again becomes active, the position indicated by the inertial navigation system can be matched to the position determined by the global positioning system.

According to yet another advantageous embodiment of the invention, the arrangement's sighting-related equipment comprises a sight with two image-generating sensors, one sensor working within the visual frequency range and the other sensor working within the thermal frequency range, with the image from the first sensor being combined with the image from the second sensor to generate a sight image in the display device. By combining the images, an arrangement is obtained with a greater ability to detect targets. The display device is advantageously designed to display the sight image with additional superimposed information obtained from sources of information other than the two image-generating sensors. The soldier has thereby access to comprehensive information in one and the same place.

According to another embodiment of the invention, the equipment for taking measurements comprises a pulsed laser for, among other things, range finding. The pulsed laser can suitably be designed to be used for range finding, target indication and training. The same laser can thus be utilized for several tasks.

According to a proposed embodiment, communication with the environment can be carried out using data packets. Here, the environment means both other soldiers and command functions.

An embodiment of the arrangement, comprising a group of soldiers, is characterized in that the equipment for communication with the environment is designed to be able to transfer information directly between individual soldiers. By this means, a soldier can transfer information about target and positions directly to his group of soldiers or to individual soldiers in the group in a simple way. By this means, it is also possible to give warning in situations where a soldier is aiming his weapon at another soldier who could be concealed behind a wall or the like.

The invention will be described in greater detail below with reference to the attached drawings, in which:

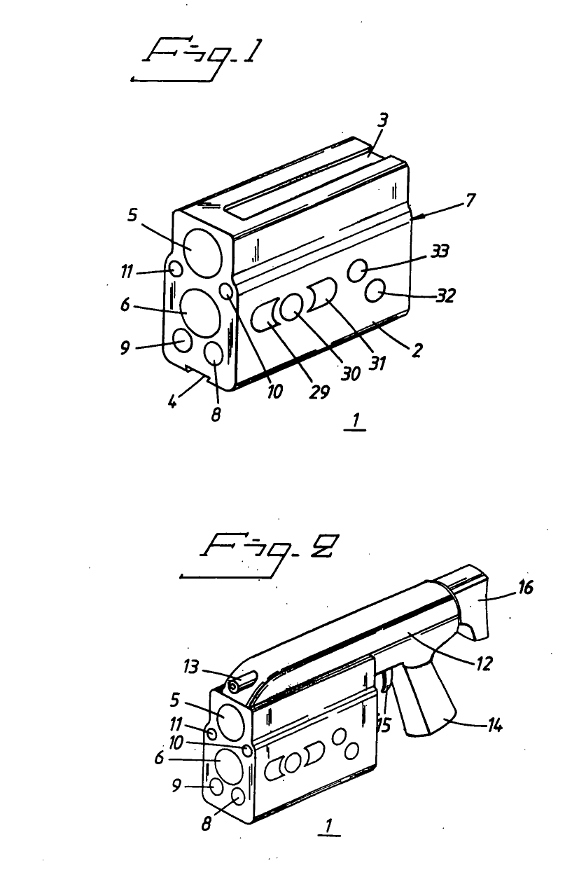

FIG. 1 shows sighting-related equipment that is intended to be hand-held in an arrangement for management of a soldier according to the invention.

FIG. 2 shows sighting-related equipment that is mounted on a weapon in an arrangement for management of a soldier according to the invention.

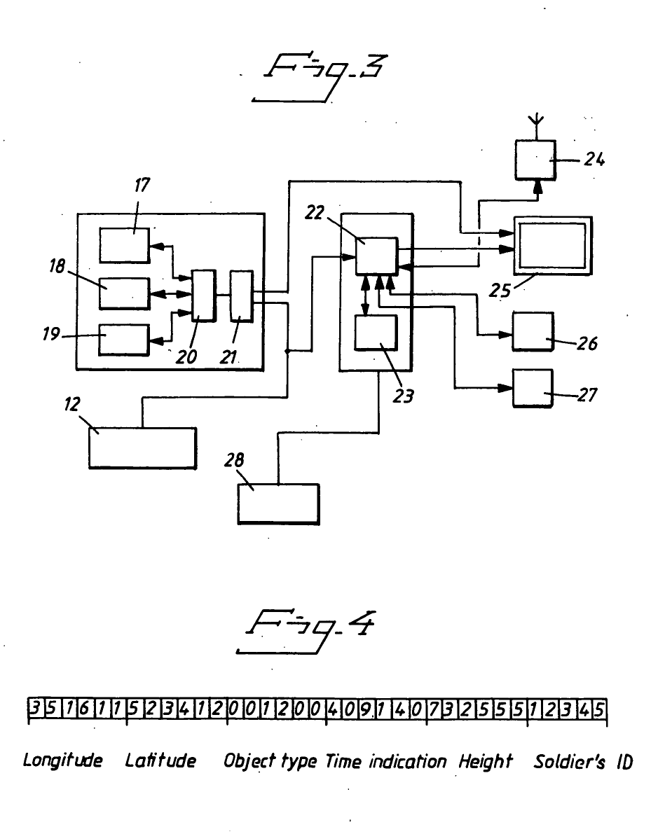

FIG. 3 shows schematically in the form of a block diagram examples of functions comprised in the arrangement according to the invention.

FIG. 4 shows schematically an example of a data packet for transmitting information via a radio network from one soldier to other soldiers, a military vehicle or command functions.

The arrangement's sighting-related equipment 1 shown in FIG. 1 for management of a soldier in network-based warfare is provided with a casing 2. The casing 2 is provided with a means for fixing 3, 4 on the upper side and the underside respectively. In the embodiment shown, the means for fixing can interact with dovetails (not shown) for connecting, for example, a handle or for attaching the casing 2 to a strap or to a suitable part of the soldier's equipment. It is also possible to arrange the equipment on a supporting weapon. The equipment 1 has an infrared input 5 and an input 6 for visual light. A display device 7, not shown in greater detail, can be arranged on the back of the equipment in order to be viewed by the soldier. Alternatively, the display device can be arranged in front of the soldier's eyes. This can, for example, be carried out by the display device being mounted on the soldier's helmet or being held in place by some form of strap that can go round the soldier's helmet or round the soldier's head. At the front of the equipment there are additional inputs and/or outputs 8-11. These inputs and/or outputs can, for example, be used for laser range finders, lowlight cameras, laser pointers, training systems with IFF function, etc. On the long side of the equipment there are a plurality of buttons 29-33 for setting various functions of the arrangement's sighting-related equipment. For example, a mouse function can be created by means of the buttons 29-31, while the buttons 32 and 33 can be used for activating the laser pointer and training system respectively.

According to FIG. 2, the sighting-related equipment 1 is integrated with a weapon 12. The weapon 12 illustrated has a barrel 13, a handgrip 14, a trigger 15 and a butt end 16. In the embodiment illustrated, the sighting-related equipment 1 is attached to the weapon 12 by a screw connection. Other fixing methods are possible, ranging from more or less permanent connections to quick-release connections.

FIG. 3 shows examples of functions that can be comprised in the arrangement according to the invention. The sighting-related equipment 1 comprises here an infrared sensor 17, a sensor for visual light 18 and a pulsed laser 19. The laser 19 can be used for range finding, target indication and training. The equipment 1 comprises, in addition, a processor 20 and an interface 21 to external units. A portable computer 22 with memory 23 is connected to the equipment 1 and can be attached to the soldier's belt. Other examples of external units carried by the soldier are communication equipment 24, a display device 25, an inertial navigation system 26 and a global navigation system 27, such as GPS.

In addition, a weapon 12 is connected to the equipment 1 electrically and possibly mechanically. Alternatively, the weapon can be connected electrically to the computer 22. One or several batteries 28 supply the soldier's equipment with power.

A continually-updated position image makes capacity requirements on the transfer medium. The arrangement must be able to maintain radio connection for the transmission of data between soldiers, between soldier and vehicle and between soldier and command function. This must be achieved using a restricted bandwidth and accordingly a restricted quantity of data that can be transferred per unit of time. In order to achieve the transmission, data is sent in data packets utilizing known compression principles. An example of a data packet is shown in FIG. 4. The data packet contains here six pieces of information, namely information about longitude, latitude, object type, time indication, height and soldier's ID.

The solution with an inertial navigation system and a global navigation system provides the soldier with a good position indication in three coordinates with regard to his own position and also with regard to other units in the group. Updating by the global GPS system is carried out when this is possible.

By means of the arrangement according to the invention, the command function or the soldier can quickly specify targets to a shooting unit, a comrade or supporting vehicle. Paths for advance can be indicated and the soldier can use the equipment even in poor visibility. Upon receiving target data, a marksman can quickly aim his weapon at the target by means of guidance to the target object. It is also possible to attack a target that is concealed, for example behind a wall. In addition, the soldier can be warned if his weapon is aimed towards a position where his own unit is located. A built-in training system can be configured to be used as IFF equipment. It is also possible to open fire simultaneously.

Among other things, the arrangement according to the invention can be designed to carry out the following functions:
Measurement and designation of target
Detection of target by combining data from sensors and image processing
Superimposing of sight images from members of the group
Distribution of target object and provision of guidance to an object
Reception of target object and generation of guidance to an object
Training with IFF functionality
Target indication by laser
Arming of ammunition
Setting up of reticle for individual firing
Range finding
Display of oleate information directly onto sight images and map images
Storage of data for “after action review”

The arrangement is not limited to the embodiments descried above, but can be modified within the framework of the following patent claims and concept of the invention.

1. An arrangement for management of a soldier in network-based warfare, the arrangement comprising:
sighting-related equipment for position determination, taking measurements and communication with the environment,
a combined unit carried by the soldier and operative to accommodate the sighting-related equipment, and
a display device operative to at least partially display information produced by the sighting-related equipment.

2. The arrangement according to claim 1, further comprising:
means for mounting the sighting-related equipment on a weapon carried by the soldier.

3. The arrangement according to claim 1, wherein the sighting-related equipment is designed to be hand-held in the same way as a telescope.

4. The arrangement according to claim 1, wherein the equipment for position determination comprises an inertial navigation system.

5. The arrangement according to claim 1, wherein the equipment for position determination comprises a positioning system of the global type.

6. The arrangement according to claim 4, wherein the equipment for position determination comprises an inertial navigation system working together with a positioning system of the global type.

7. The arrangement according to claim 1, wherein the sighting-related equipment comprises a sight with two image-generating sensors, one sensor working within the visual frequency range and another sensor working within the thermal frequency range, with the image from the first sensor being combined with the image from the second sensor to generate a sight image in the display device.

8. The arrangement according to claim 7, wherein the display device is designed to display the sight image with superimposed information obtained from sources of information other than the two image-generating sensors.

9. The arrangement according to claim 1, wherein the equipment for taking measurements comprises a pulsed laser for, among other things, range finding.

10. The arrangement according to claim 9, wherein the pulsed laser is designed to be used for range finding, target indication and training.

11. The arrangement according to claim 1, wherein the arrangement is designed to communicate with the environment using data packets.

12. The arrangement according to claim 1, wherein the equipment for communication with the environment is designed to be able to transfer information directly between individual soldiers.

13. The arrangement according to claim 1, wherein the equipment for position determination comprises GPS.
